(19) United States
(12) Patent Application Publication
(10) Pub. No.: US 2026/0274257 A1
(43) Pub. Date: Sep. 17, 2026

(54) DYNAMIC ROAD SPEED LIMITER AND METHOD

(71) Applicant: International Truck Intellectual Property Company, LLC, Lisle, IL (US)

(72) Inventors: Bhupendra Jadhav, Chicago, IL (US); Will Weissberg, Ray, MI (US); Christopher James La Fontaine, Macomb, MI (US); Sateesh Kolli, Aurora, IL (US)

(73) Assignee: International Truck Intellectual Property Company, LLC, Lisle, IL (US)

(21) Appl. No.: 19/081,003

(22) Filed: Mar. 17, 2025

(51) Int. Cl. B60W 30/14; B60W 50/00

(52) U.S. Cl. CPC B60W 30/146; B60W 2050/0082; B60W 2540/215; B60W 2720/40

(57) ABSTRACT

A dynamic road speed limiter is provided for limiting road speed operational parameters for vehicles demonstrating triggering conditions. The dynamic road speed limiter may include a dynamic road speed limiter, electronic control unit (ECU), triggering detection component and torque management control aspect to control torque output to maintain the dynamic limiting speed. A method for limiting road speed operational parameters for vehicles demonstrating triggering conditions using the dynamic road speed limiter is also provided.

### FIELD OF THE INVENTION

The present disclosure relates to a dynamic road speed limiter. More particularly, the disclosure relates to limiting road speed operational parameters for vehicles demonstrating triggering conditions.

### BACKGROUND

Current implementations of road speed limiters compromise the safety and efficiency of vehicles. One example of a current road speed limiter includes derates based on time duration, however, these do not account for the severity or variability of the triggering conditions, such as engine temperature, oil pressure, or fuel level. Another example of a current road speed limiter is a one-step derate, which reduces torque abruptly or imposes a fixed speed limit. These may be hazardous or undesirable in certain situations, such as on a slope or in traffic. Overall, with current implementations, the operator has limited or no control over the vehicle speed and cannot adapt it to the road and traffic conditions. In result, this may increase the risk of accidents or damage to the vehicle.

Therefore, a need exists to solve the deficiencies present in the prior art. What is needed is a speed limiter that will decrease vehicle speed while ensuring the vehicle is operating within its safety envelope under detectable operating conditions. What is needed is an apparatus that can be used supplementally with traditional road speed limiters. What is needed is a powertrain control device that can be switched between active and inactive states, due to a triggering event and/or manually, to manage the vehicle speed due to driving, powertrain, and/or other conditions.

### SUMMARY

An aspect of the disclosure advantageously provides a speed limiter that will decrease vehicle speed while ensuring the vehicle is operating within its safety envelope under detectable operating conditions. An aspect of the disclosure advantageously provides an apparatus that can be used supplementally with traditional road speed limiters. An aspect of the disclosure advantageously provides a powertrain control device that can be switched between active and inactive states, due to a triggering event and/or manually, to manage the vehicle speed due to driving, powertrain, and/or other conditions.

Accordingly, the disclosure may feature a dynamic road speed limiter for a vehicle comprising a trigger detection component which may detect a triggering event of the vehicle. The triggering event may be analyzed on an electronic control unit (ECU) of the vehicle which may determine a dynamic road speed limiting operation state. Analyzing the triggering event may comprise the steps of setting a dynamic road speed limiter to an active state upon detecting the triggering event that is occurring or, upon determining that the triggering event has not occurred, setting the dynamic road speed limiter to an inactive state. When the dynamic road speed limiter is operating in an active state, it may perform the steps of determining a current speed via the ECU, setting a dynamic limiting speed of the vehicle to not exceed the current speed, and monitoring the current speed to detect a decrease of the current speed and match the dynamic limiting speed to the current speed that may be decreased not to surpass a target threshold speed. The dynamic road speed limiter may also comprise a torque management control aspect. The torque management control aspect may perform the steps of receiving a torque demand from an operator via a torque demand component which may be communicably connected to the ECU, comparing the torque demand to the dynamic limiting speed if the dynamic road speed limiter is in the active state, and restricting a torque output of an engine of the vehicle to not exceed the dynamic limiting speed.

In another aspect, the ECU in the active state may control the torque output of the engine such that the current speed cannot exceed the dynamic limiting speed.

In another aspect, the triggering event may comprise a fault condition.

In another aspect, upon the fault condition being detected, the dynamic road speed limiter may be selectively used with traditional road speed limiters.

In another aspect, the triggering event may comprise a manual activation.

In another aspect, the dynamic road speed limiter may continuously monitor for the triggering event while in the active state.

In another aspect, the torque output may be variable to compensate for changes in increased torque demands required to maintain the dynamic limiting speed.

In another aspect, the increased torque demands may comprise moving the vehicle that is traveling with dynamic road conditions.

Accordingly, the disclosure may feature a method of dynamic road speed limiting for a vehicle, which may comprise detecting a triggering event of the vehicle via a triggering detection component that may be analyzed on an electronic control unit (ECU) of the vehicle to determine a dynamic road speed limiting operation state. Detecting a triggering event may comprise the steps of setting a dynamic road speed limiter to an active state upon detecting the triggering event is occurring, and setting the dynamic road speed limiter to an inactive state upon determining that the triggering event has not occurred. While the dynamic road speed limiter is in an active state, it may comprise the steps of determining a current speed via the ECU, setting a dynamic limiting speed of the vehicle to not exceed the current speed, and monitoring the current speed to detect a decrease of the current speed and matching the dynamic limiting speed to the current speed that is decreased not to surpass a target threshold speed. The method of dynamic road speed limiting may further comprise enacting a torque management control aspect that may operate comprising the steps of receiving a torque demand from an operator via a torque demand component communicably connected to the ECU, comparing the torque demand to the dynamic limiting speed if the dynamic road speed limiter is in the active state, and restricting a torque output of an engine of the vehicle to not exceed the dynamic limiting speed.

In another aspect, the ECU in the active state may control the torque output of the engine such that the current speed may not exceed the dynamic limiting speed.

In another aspect, the triggering event may comprise a fault condition.

In another aspect, upon the fault condition being detected, the dynamic road speed limiter may be selectively used with traditional road speed limiters.

In another aspect, the triggering event may comprise a manual activation.

In another aspect, the dynamic road speed limiter may continuously monitor for the triggering event while in the active state.

In another aspect, the torque output may be variable to compensate for change in increased torque demands required to maintain the dynamic limiting speed.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative dynamic road speed limiter included by a vehicle, according to an embodiment of this disclosure.

FIG. 2 is a flowchart view of an illustrative operation of a dynamic road speed limiter, according to an embodiment of this disclosure.

FIG. 3 is a graph view of an illustrative interaction between a triggering event and time for a first example, according to an embodiment of this disclosure.

FIG. 4 is a graph view of an illustrative interaction between a torque demand and time for a first example, according to an embodiment of this disclosure.

FIG. 5 is a graph view of an illustrative interaction between a pedal position and time for a first example, according to an embodiment of this disclosure.

FIG. 6 is a graph view of an illustrative interaction between a vehicle speed and time for a first example, according to an embodiment of this disclosure.

FIG. 7 is a graph view of an illustrative interaction between a triggering event and time for a second example, according to an embodiment of this disclosure.

FIG. 8 is a graph view of an illustrative interaction between a torque demand and time for a second example, according to an embodiment of this disclosure.

FIG. 9 is a graph view of an illustrative interaction between a pedal position and time for a second example, according to an embodiment of this disclosure.

FIG. 10 is a graph view of an illustrative interaction between a vehicle speed and time for a second example, according to an embodiment of this disclosure.

FIG. 11 is a graph view of an illustrative interaction between a triggering event and time for a third example, according to an embodiment of this disclosure.

FIG. 12 is a graph view of an illustrative interaction between a torque demand and time for a third example, according to an embodiment of this disclosure.

FIG. 13 is a graph view of an illustrative interaction between a pedal position and time for a third example, according to an embodiment of this disclosure.

FIG. 14 is a graph view of an illustrative interaction between a vehicle speed and time for a third example, according to an embodiment of this disclosure.

### DETAILED DESCRIPTION

The following disclosure is provided to describe various embodiments of a dynamic road speed limiter. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term electronic control unit (ECU), as it is used throughout this disclosure, is defined as an electronic system of a vehicle that controls one or more electrical systems in a vehicle, such as the torque output. The term torque demand component, as it is used throughout this disclosure, is defined as a component of a vehicle that increases the request for a torque output of a vehicle. As used herein, a torque demand component may include, without limitation, an accelerator pedal as well as any number of automated processes effected through an ECU, which processes would be readily appreciated by those skilled in the art. The term dynamic limiting speed, as it is used throughout this disclosure, is defined as a variable speed limit that may limit a vehicle speed when the dynamic road speed limiter is in an active state. The term target threshold speed, as it is used throughout this disclosure, is defined as a variable goal speed when the dyanmic road speed limiter is in an active state.

Various aspects of the present disclosure will now be described in detail, without limitation. In the following disclosure, a dynamic road speed limiter will be discussed. Those of skill in the art will appreciate alternative labeling of the dynamic road speed limiter as a road speed limiter, dynamic speed limiting system, manageable vehicular speed controller, the invention, or other similar names. Similarly, those of skill in the art will appreciate alternative labeling of the dynamic road speed limiter as a method of regulating vehicle speed in response to triggering conditions, speed limiting method to affect engine output levels, engine control steps to mitigate powertrain triggering conditions, method, operation, the invention, or other similar names. Skilled readers should not view the inclusion of any alternative labels as limiting in any way.

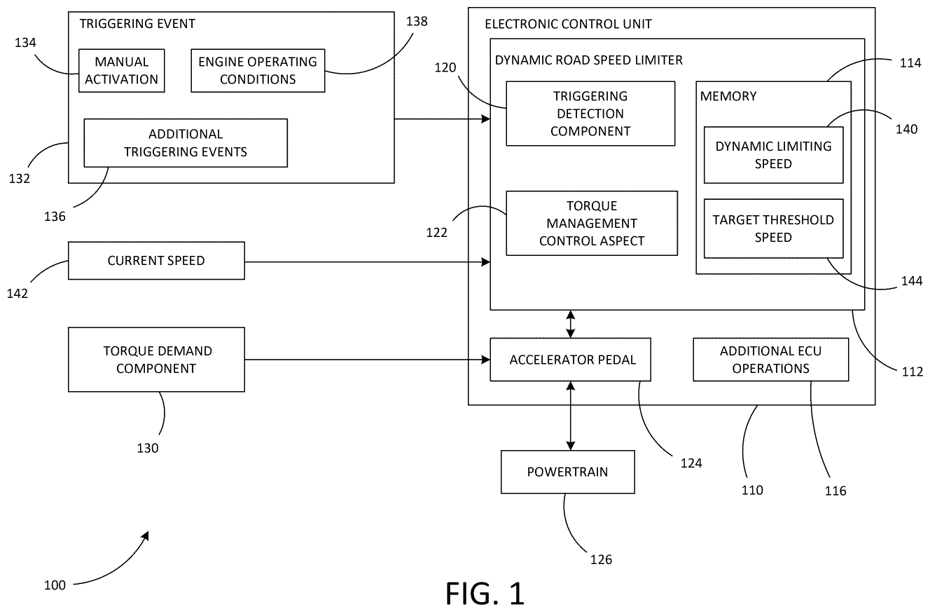

Referring now to FIGS. 1-14, the dynamic road speed limiter 112 will now be discussed in more detail. The dynamic road speed limiter system 100 may include a dynamic road speed limiter 112, an electronic control unit (ECU) 110, triggering detection component 120, torque management control aspect 122, and additional components that will be discussed in greater detail below. The dynamic road speed limiter 112 may operate one or more of these components interactively with other components for limiting road speed operational parameters for vehicles demonstrating triggering conditions.

The dynamic road speed limiter 112 will now be discussed in greater detail. FIGS. 1-14 highlight examples of the dynamic road speed limiter, which may also be shown in other figures.

Overall, the dynamic road speed limiter 112 may improve vehicle speed controllability by an operator of the vehicle. In various embodiments, the dynamic road speed limiter 112 may comprise a triggering detection component 120, a torque management control aspect 122, and/or a memory 114, without limitation, which will be discussed in greater detail below. The triggering detection component 120 may detect a triggering event 132, which then may be analyzed to determine whether the dynamic road speed limiting operation state of the dynamic road speed limiter 112 needs to change to an active state or an inactive state. If the triggering detection component 120 sets the dynamic road speed limiter 112 to an inactive state, the dynamic road speed limiter 112 may be in an idle state. If the triggering detection component 120 sets the dynamic road speed limiter 112 to an active state, the dynamic road speed limiter 112 may perform further operations to control the torque output and operation of a vehicle.

In various embodiments, when the dynamic road speed limiter 112 is in an active state, the dynamic road speed limiter 112 may first determine a current speed 142, 542, 1042, 1442 of the vehicle via the electronic control unit (ECU) 110. Next, the dynamic road speed limiter 112 may set a dynamic limiting speed 140, 540, 1040, 1440 of the vehicle to not exceed the current speed 142, 542, 1042, 1442. The dynamic limiting speed 140, 540, 1040, 1440 of the vehicle may advantageously allow an operator to maintain the speed the vehicle was driving at without permitting the vehicle to accelerate above the current speed of the vehicle. Thus, the dynamic road speed limiter 112 may continue monitoring the current speed 142, 542, 1042, 1442 to detect a decrease of the current speed 142, 542, 1042, 1442 and match the dynamic limiting speed 140, 540, 1040, 1440 to the new, decreased current speed 142, 542, 1042, 1442. The dynamic road speed limiter 112 may continue the aforementioned detection and continue to decrease the dynamic limiting speed 140, 540, 1040, 1440 to the greater of the lowest measured current speed 142, 542, 1042, 1442 detected during the active state or a target threshold speed 144, 544.

In embodiments, when the dynamic road speed limiter 112 is in an active state, the dynamic limiting speed 140, 540, 1040, 1440 of the vehicle may be set to a high speed that may be of equal or about equal value of the vehicle's current speed 142, 542, 1042, 1442 at the time the active state was initiated, which theoretically could be the maximum possible speed of the vehicle when operating under normal conditions. As the current speed 142, 542, 1042, 1442 decreases, the dynamic limiting speed 140, 540, 1040, 1440 may be adjusted downward to place a new maximum speed restriction on the vehicle to match the lowest detected current speed 142, 542, 1042, 1442 so long as such current speed is not lower than the target threshold speed 144, 544.

Additionally, in various embodiments, the dynamic road speed limiter 112 may continuously monitor to determine if the triggering event 132 is still occurring, while the dynamic road speed limiter 112 is in an active state and/or inactive state. Thus, if a triggering event 132 has occurred, and the dynamic road speed limiter 112 has been set to an active state, the dynamic road speed limiter 112 will continue to monitor if the triggering event 132 is still occurring. If the triggering event 132 has stopped, the dynamic road speed limiter 112 may be switched to an inactive state. However, with the benefit of this disclosure, those skilled in the art will appreciate the various monitoring mechanisms that may be employed within the dynamic road speed limiter 112.

In embodiments, when the dynamic road speed limiter 112 is in an active state, once the current speed 142, 542, 1042, 1442 of the vehicle has reached or decreased lower than a target threshold speed 144, 544, the dynamic limiting speed 140, 540, 1040, 1440 may be set equal to the target threshold speed 144, 544. Thus, if the current speed 142, 542, 1042, 1442 is lower than the target threshold speed 144, 544, the operator may advantageously increase the current speed 142, 542, 1042, 1442 of the vehicle until the vehicle has reached the target threshold speed 144, 544 and/or dynamic limiting speed 140, 540, 1040, 1440. However, if the operator attempts to increase the current speed 142, 542, 1042, 1442 over the target threshold speed 144, 544 and/or dynamic limiting speed 140, 540, 1040, 1440, the dynamic road speed limiter 112 may restrict this action and may limit the torque output 420, 820, 1220 of the vehicle, so that the current speed 142, 542, 1042, 1442 is equal or less than the target threshold speed 144, 544 and dynamic limiting speed 140, 540, 1040, 1440.

In various embodiments, the dynamic road speed limiter 112 may further comprise a torque management control aspect 122, which may advantageously and selectively restrict the torque output 420, 820, 1220 of the vehicle. The torque management control aspect 122 may generally receive a torque demand from an operator via a torque demand component 130, 530, 930, 1330, which may be communicably connected to the ECU 110. Next, the torque management control aspect 122 may compare the torque demand to the dynamic limiting speed 140, 540, 1040, 1440, if the dynamic road speed limiter 112 is in the active state. Then, the torque management control aspect 122 may restrict a torque output 420, 820, 1220 of an engine of the vehicle to not exceed the dynamic limiting speed 140, 540, 1040, 1440, without limitation.

In various embodiments, the dynamic road speed limiter 112 may be used in conjunction with traditional road speed limiters, upon the detection of a triggering event 132. Traditional road speed limiters include, but are not limited to, time based derates, one step derate, and/or one step torque derates. Time based derates may be based on the time duration for which the derate condition has been active. In this type of derate, the longer the derate is active, the harsher the derate will be. One step derates may be based on cutting the torque of the vehicle until the current speed 142, 542, 1042, 1442 of the vehicle comes down to a target threshold speed 144, 544. Additionally, the current speed 142, 542, 1042, 1442 of the vehicle may then only be limited by the target threshold speed 144, 544. One step torque derates may be similar to one step derates, however, may comprise different target threshold speeds 144, 544 based on terrain, vehicle load, etc., without limitation. Those skilled in the art will appreciate the various other traditional road speed limiters that may be implemented in a vehicle, after having the benefit of this disclosure.

The electronic control unit (ECU) 110 will now be discussed in greater detail. FIG. 1 highlights an example of the electronic control unit (ECU), which may also be shown in other figures.

As previously mentioned, the electronic control unit 110 may house a dynamic road speed limiter 112, a torque control 124, and/or additional ECU operations 116, including microprocessors, memory 114, communication interfaces, and input/output ports, without limitation. In various embodiments, the ECU 110 may control various aspects of the vehicle's dynamics, such as engine speed, fuel injection, ignition timing, and/or emission control, without limitation.

In other embodiments, the ECU 110 may advantageously communicate with a powertrain 126, torque demand component 130, 530, 930, 1330, the current speed 142, 542, 1042, 1442 of the vehicle, and/or the triggering event 132, without limitation. Moreover, the ECU 110 may receive input signals from various sensors, such as accelerator pedal position, oxygen level, and engine temperature, without limitation. The ECU 110 may generate output signals to actuate various actuators.

Furthermore, the ECU 110 may further communicate with other devices located inside the vehicle, such as the display, the navigation system, and the torque demand component, without limitation. The ECU 110 may be programmed with software that may implement various algorithms and logic for various purposes such as controlling the vehicle's performance and efficiency, without limitation. Additionally, the ECU 110 may store data related to the vehicle's operation, such as diagnostic codes, fuel consumption, driving patterns, and environmental conditions, without limitation.

The triggering detection component 120 will now be discussed in greater detail. FIG. 1 highlights an example of the triggering detection component, which may also be shown in other figures.

In various embodiments, as previously mentioned, the dynamic road speed limiter 112 may additionally comprise a triggering detection component 120. The triggering detection component 120 may advantageously detect a triggering event 132, which will be described in greater detail below, which may be analyzed to determine whether a dynamic road speed limiting operation state of the dynamic road speed limiter 112 should be switched to an active state or inactive state.

In embodiments, the triggering detection component 120 may be configured to receive input signals from various sources, without limitation. The triggering detection component 120 may process the input signals. The processing of input signals of the triggering detection component 120 may also include comparing the input signals to operational criteria to determine whether a triggering event 132 has occurred. Consequently, once the triggering detection component 120 has detected a triggering event 132, the triggering detection component 120 may communicate with other parts of the dynamic road speed limiter 112 to enable or disable the dynamic road speed limiter 112. Those skilled in the art will appreciate the various features that may communicate with one another within the triggering detection component 120, after having the benefit of this disclosure.

In various embodiments, the triggering detection component 120 may further comprise a memory 114 and a processor. The memory 114 may store the operational criteria and/or input signals received from sources via the triggering event 132. The processor may process the input signals and compare them with the operational criteria. The processor may additionally generate output signals to enable and/or disable the dynamic road speed limiter 112. Those skilled in the art will appreciate the various components of the triggering detection component 120, after having the benefit of this disclosure.

In some embodiments, the triggering event 132 may comprise manual activation 134, engine operating conditions, and/or additional triggering events 136, without limitation.

Manual activation 134 may comprise an operator manually switching the triggering detection component 120 from an active state to an inactive state or from an inactive state to an active state. An operator may advantageously choose to manually activate the dynamic road speed limiter 112 for several reasons, including, but not limited to, entering a road with variable or unknown speed limits, such as a construction zone, a school zone, or a rural area. Alternatively, an operator may choose to manually inactivate the dynamic road speed limiter 112 when the operator would like to have more control over the vehicle's acceleration and deceleration, such as in an emergency situation, a passing maneuver, or a steep incline or decline, without limitation. Manual activation 134 may be performed by pressing a button, flipping a switch, touching a screen, or using voice commands, without limitation. Those skilled in the art, however, will realize the various mechanisms that one may use to activate or deactivate manual activation 134 of a triggering event, after having the benefit of this disclosure.

In the same or other embodiments, the triggering event 132 may also enable or disable the dynamic road speed limiter 112 due to a change in engine operating conditions 138 and/or fault conditions. Engine operating conditions 138 and/or fault conditions may comprise numerous factors that affect the performance, efficiency, and safety of the engine, such as temperature, pressure, fuel level, oil level, emissions, or any other relevant factors, without limitation. Those skilled in the art will appreciate the various factors that may affect a variety of engine conditions and/or fault conditions, after having the benefit of this disclosure. In embodiments, the triggering detection component 120 may monitor one or more of the engine operating conditions 138 and enable or disable the dynamic road speed limiter 112 accordingly. Examples include an engine overheating above a certain threshold and/or a decrease of power of an engine, without limitation. Those skilled in the art, however, will appreciate the various types and combinations of engine operating conditions 138 that may trigger the dynamic road speed limiter 112, after having the benefit of this disclosure.

In various embodiments, the triggering event 132 may also enable or disable the dynamic road speed limiter 112 due to other triggering events 136. Examples of other triggering events 136 that may enable or disable the dynamic road speed limiter 112 include a change in road conditions or vehicle conditions, without limitation. In various embodiments, factors that may be considered for a change in road conditions include road surface, curvature, or elevation, without limitation. In the same or different embodiments, factors that may be considered for a change in vehicle conditions include acceleration, braking, steering, tire pressure, heat, or battery level, without limitation. Those skilled in the art will appreciate the various types of other triggering events 136 that may enable or disable the dynamic road speed limiter 112, after having the benefit of this disclosure.

The torque management control aspect 122 will now be discussed in greater detail. FIG. 1 highlights an example of the torque management control aspect, which may also be shown in other figures.

As previously mentioned, the torque management control aspect 122 may operate by receiving a torque demand from an operator via a torque demand component 130, 530, 930, 1330, which may be communicably connected to the ECU 110. The torque management control aspect 122 may then compare the torque demand to the dynamic limiting speed 140, 540, 1040, 1440 if the dynamic road speed limiter 112 is in the active state. Next, the torque management control aspect 122 may restrict a torque output 420, 820, 1220 of an engine of the vehicle, which may not be permitted to exceed the dynamic limiting speed 140, 540, 1040, 1440. Those skilled in the art, however, will appreciate the addition and/or deletion of various steps in the operation of the torque management control aspect 122.

Additionally, the torque management control aspect 122 may communicate with other parts of the ECU 110. In turn, the ECU 110 may control the torque output 420, 820, 1220 of the engine, so that that the current speed 142, 542, 1042, 1442 will not exceed beyond the dynamic limiting speed 140, 540, 1040, 1440, when the dynamic road speed limiter 112 is in an active state.

In various embodiments, the torque output 420, 820, 1220 may be variable to compensate for changes in increased torque demands that may be required to maintain the dynamic limiting speed 140, 540, 1040, 1440. Increased torque demands may be caused by dynamic road conditions, which may include moving a larger mass by the vehicle, driving on a steep slope, and/or driving through a strong headwind, without limitation. Those skilled in the art will appreciate the various other increase torque demands, after having the benefit of this disclosure.

In the same or other embodiments, the torque management control aspect 122 may adjust the torque output accordingly by sending appropriate signals within the ECU 110, as needed, without limitation. The variability of the torque output 420, 820, 1220 may also depend on the triggering events that activate the dynamic road speed limiter 112, without limitation.

There are various practical implications where the dynamic road speed limiter 112 may be used. Those include an instance where the dynamic road speed limiter 112 is turned on automatically after a triggering event 132 has occurred, an instance where the dynamic road speed limiter 112 is manually activated, and an instance where the dynamic road speed limiter 112 is manually activated and then a triggering event 132 occurs, so the traditional road speed limiters are activated, without limitation. Those skilled in the art will appreciate the various other implications where the dynamic road speed limiter 112 may be used, after having the benefit of this disclosure.

In operation, a method may be provided for limiting road speed operational parameters for vehicles demonstrating triggering conditions. Those of skill in the art will appreciate that the following methods are provided to illustrate an embodiment of the disclosure and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

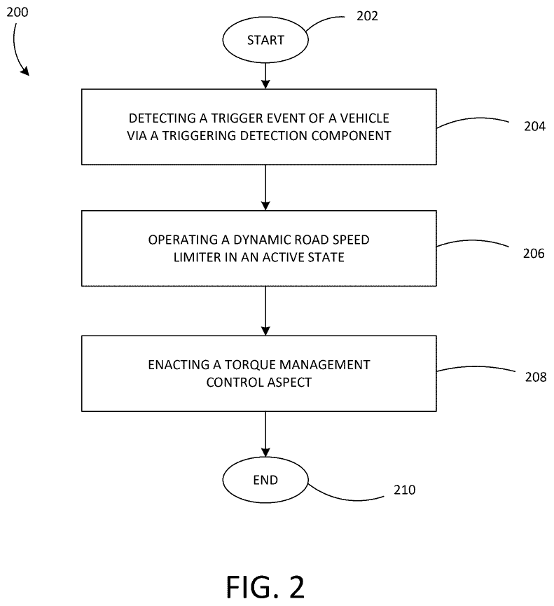

Referring now to flowchart 200 of FIG. 2, an example method for an illustrative operation of a dynamic road speed limiter will be described in the context of the above disclosure, without limitation. Starting with Block 202, the operation may begin by detecting a triggering event of a vehicle via a triggering detection component (Block 204). Next, the operation may continue by operating a dynamic road speed limiter in an active state, during which the dynamic limiting speed may be maintained and adjusted during the active state (Block 206). Then, the operation may continue by enacting a torque management control aspect, in which the torque output of the powertrain may be affected to maintain the dynamic limiting speed (Block 208). The operation may end with Block 210.

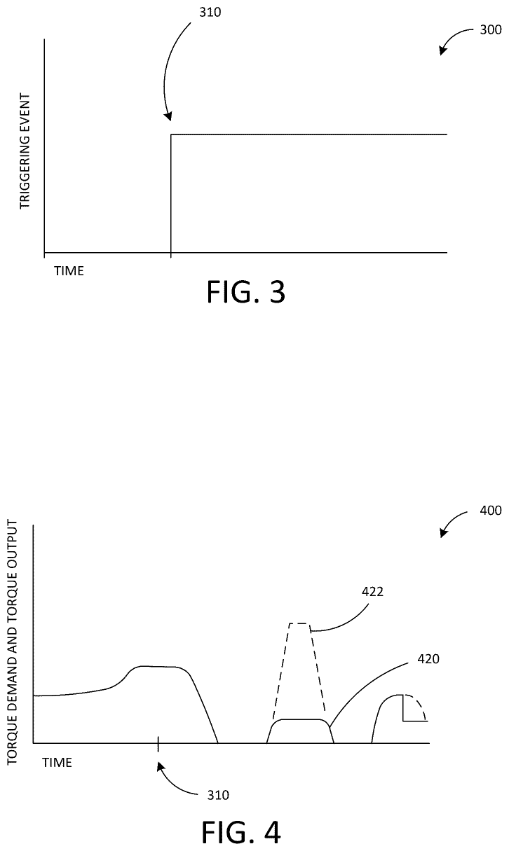

As seen in FIGS. 3-6, an example where the dynamic road speed limiter is turned on automatically after a triggering event has occurred can be seen.

FIG. 3 shows a graph of the triggering event versus time 300. More particularly, there is no triggering event until time event 310. After time event 310, the triggering event has occurred/is still occurring, thus showing a horizontal line at a value greater than zero.

FIG. 4 shows a graph of the torque demand and torque output versus time 400. More particularly, before time event 310, the operator is driving at a constant speed, then increases their speed slightly. At time event 310, the operator attempts to increase their speed, but is limited by the dynamic road speed limiter. The operator then decreases the vehicle's torque output, so the vehicle speed decreases. After time event 310, the operator attempts to increase the vehicles speed twice, however, is limited due to the dynamic road speed limiter being active; this can be illustrated by torque output 420 and torque demand 422.

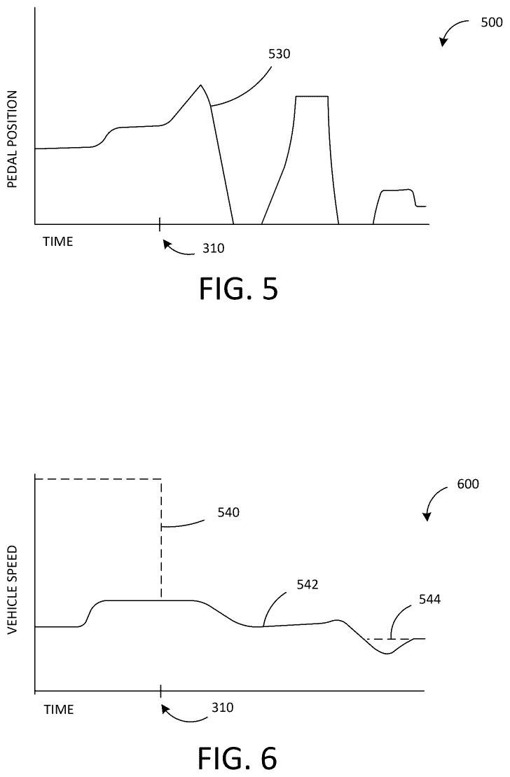

FIG. 5 shows a graph of the pedal position versus time 500. As discussed previously, before time event 310, the operator drives at a constant speed, and then increases their speed, and thus, their pedal position, slightly. At time event 310, as discussed previously, the operator attempts to increase their speed, but increasing their pedal position, however, is stopped by the dynamic road speed limiter. After time event 310, the operator attempts to increase the vehicle's speed twice, as illustrated by pedal position 530, however, is once again limited by the dynamic road speed limiter.

FIG. 6 shows a graph of the vehicle speed versus time 600. As discussed previously, before time event 310, the operator drives at their current speed 542. Before time event 310, the vehicle's dynamic limiting speed 540 is at a constant high point due to the dynamic road speed limiter being in an inactive state. Once the dynamic road speed limiter is turned to an active state at time event 310, the dynamic limiting speed 540 is equal to the current speed 542 of the vehicle until it has reached the target threshold speed 544. It should also be noted that as the current speed 542 decreases, the dynamic limiting speed 540 also decreases.

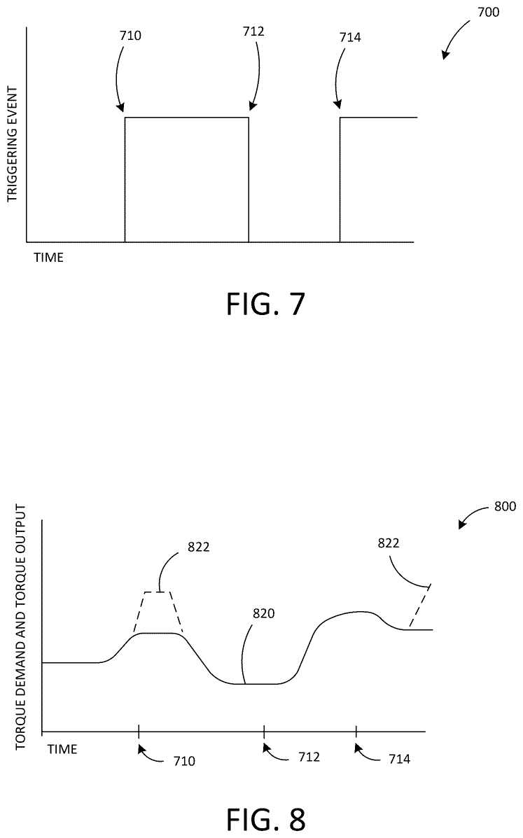

As seen in FIGS. 7-10, an example where the dynamic road speed limiter is manually activated can be seen.

FIG. 7 shows a graph of the triggering event versus time 700. More particularly, there is no triggering event before time event 710. At time event 710, the triggering event is manually activated until time event 712. At time event 712, the triggering event is manually deactivated until time event 714. At time event 714, the triggering event is manually activated. When the triggering event is activated, a horizontal line at a value greater than zero is shown. When the triggering event is deactivated, a horizontal line at zero is shown.

FIG. 8 shows a graph of the torque demand and torque output versus time 800. More particularly, before time event 710, the operator is driving at a constant speed, then increases slightly. At time event 710, the operator attempts to increase a torque demand 822, however the torque output 820 stays the same due to the dynamic road speed limiter being active. After time event 712, the dynamic road speed limiter is deactivated, so the operator is able to increase the torque output 820 freely. After time event 714, the dynamic road speed limiter is activated, so when the operator attempts to increase a torque demand 822, the torque output 820 stays the same due to the dynamic road speed limiter being active.

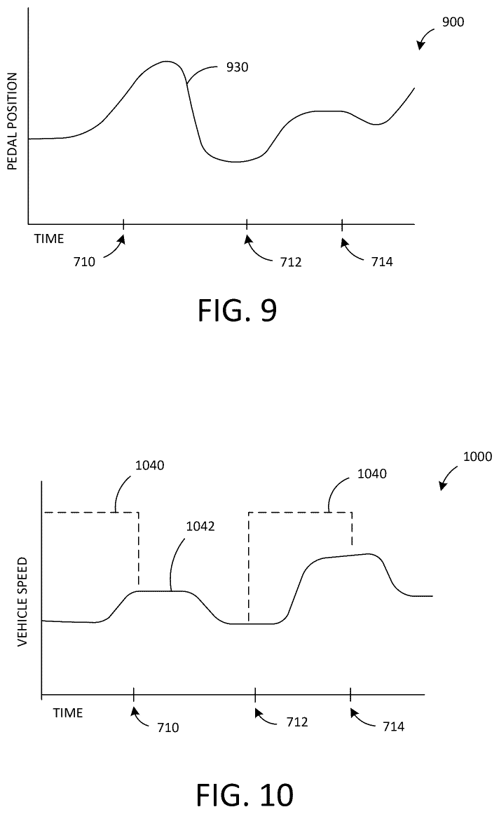

FIG. 9 shows a graph of pedal position versus time 900. As discussed previously, before time event 710, the operator drives at a constant speed, and then increases their speed, and thus, their pedal position, slightly. At time event 710, the operator attempts to increase the vehicle speed by increasing their pedal position 930. After time event 712, once the manual activation of the triggering event is turned off, the operator increases the vehicle's speed by increasing their pedal position 930. After time event 714, the operator decreases and increases their pedal position 930, however, is not able to increase the vehicle speed due to the manual activation of the triggering event being turned on.

FIG. 10 shows a graph of the vehicle speed versus time 1000. As discussed previously, before time event 710, the operator drives at their current speed 1042. Before time event 710, the vehicle's dynamic limiting speed 1040 is at a constant high point due to the dynamic road speed limiter being in an inactive state. Once the dynamic road speed limiter is turned to an active state at time event 710, the dynamic limiting speed 1040 is equal to the current speed 1042 of the vehicle. At time 712, the dynamic road speed limiter is turned to an inactive state, thus, the dynamic limiting speed 1040 returns to a constant high point. After the dynamic road speed limiter is turned to an active state at time event 714, the dynamic limiting speed 1040 is equal to the current speed 1042.

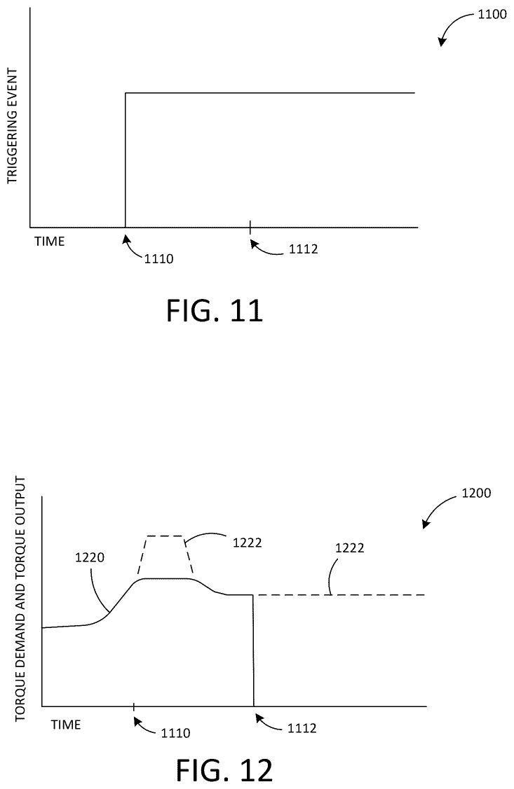

As seen in FIGS. 11-14, an example where the dynamic road speed limiter is manually activated, and then a triggering event occurs, so the traditional road speed limiters are activated can be seen.

FIG. 11 shows a graph of the triggering event versus time 1100. More particularly, there is no triggering event until time event 1110, once the dynamic road speed limiter is manually activated. At time event 1112, a triggering event, due to engine operating conditions, is detected, and thus, the traditional road speed limiters are activated. However, the triggering has occurred/is still occurring, thus showing a horizontal line at a value greater than zero after time event 1110.

FIG. 12 shows a graph of the torque demand and torque output versus time 1200. More particularly, before time event 1110, the operator is driving at a constant speed, then increases the vehicle's speed slightly. At time event 1110, the operator attempts to increase their speed by increasing the torque demand 1222, however, is limited to their current speed, and, therefore, their torque output 1220. At time event 1112, the traditional road speed limiters are activated. The operator attempts to drive the vehicle at a constant speed, as can be seen by a constant torque demand 1222, however, the traditional road speed limiters derate the vehicle speed, as can be seen by the sudden drop in torque output 1220 at time event 1112.

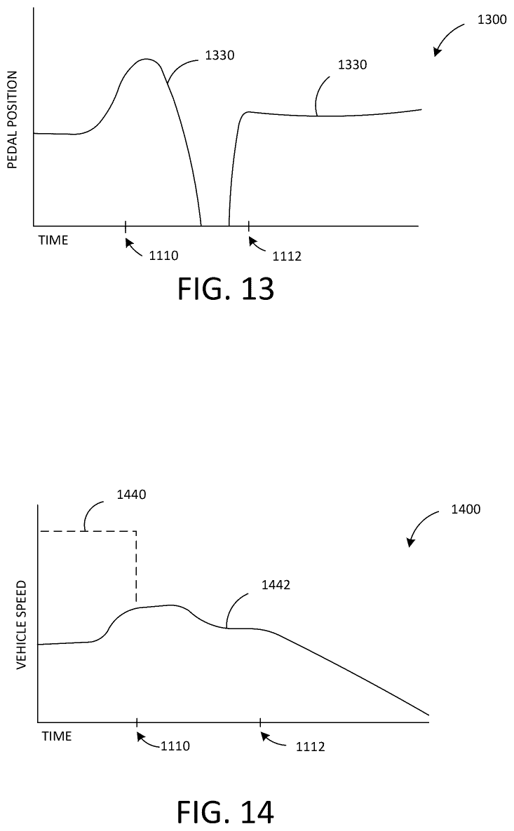

FIG. 13 shows a graph of the pedal position versus time 1300. As discussed, before time event 1110, the operator drives at a constant speed, and then increases the vehicle's speed, and thus, their pedal position. At time event 1110, the operator attempts to increase the vehicle's speed by increasing their pedal position, however, is restricted by the dynamic road speed limiter. Between time event 1110 and time event 1112, the operator decreases and then increases their pedal position 1330. After time event 1112, the operator attempts to drive the vehicle at a constant speed by holding the pedal position 1330 at a constant line.

FIG. 14 shows a graph of the vehicle speed versus time 1400. As discussed previously, before time event 1110, the operator drives the vehicle at the current speed 1442. Before time event 1110, the vehicle's dynamic limiting speed 1440 is at a constant high point due to the dynamic road speed limiter being in an inactive state. Once the dynamic road speed limiter is turned to an active state at time event 1110, the dynamic limiting speed 1440 is equal to the current speed 1442 of the vehicle. After time event 1112, traditional road speed limiters are activated, thus derating the vehicle speed 1442 at a constant decrease.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A dynamic road speed limiter for a vehicle, comprising:
a triggering detection component to detect a triggering event of the vehicle that is analyzed on an electronic control unit (ECU) of the vehicle to determine a dynamic road speed limiting operation state, by performing the steps comprising:
(a) upon determining that the triggering event is not occurring, setting a dynamic road speed limiter to an inactive state;
(b) upon detecting the triggering event is occurring, setting the dynamic road speed limiter to an active state, performing the steps comprising;
(i) determining a current speed via the ECU;
(ii) setting a dynamic limiting speed of the vehicle to not exceed the current speed;
(iii) monitoring the current speed to detect a decrease of the current speed; and
(iv) matching the dynamic limiting speed to the current speed that is decreased not to surpass a target threshold speed;
a torque management control aspect that operates in the active state by performing the steps comprising:
(c) receiving a torque demand from an operator via a torque demand component communicably connected to the ECU;
(d) comparing the torque demand to the dynamic limiting speed; and
(e) restricting a torque output of an engine such that the vehicle does not accelerate above the dynamic limiting speed.

2. The dynamic road speed limiter of claim 1, wherein the ECU in the active state controls the torque output of the engine such that the current speed cannot exceed the dynamic limiting speed.

3. The dynamic road speed limiter of claim 1, wherein the triggering event comprises a fault condition.

4. The dynamic road speed limiter of claim 3, wherein upon the fault condition being detected, the dynamic road speed limiter is selectively used with traditional road speed limiters.

5. The dynamic road speed limiter of claim 1, wherein the triggering event comprises a manual activation.

6. The dynamic road speed limiter of claim 1, wherein the triggering detection component continuously monitors for the triggering event while in the active state.

7. The dynamic road speed limiter of claim 1, wherein the torque output is variable to compensate for increased torque demands required to maintain the dynamic limiting speed.

8. The dynamic road speed limiter of claim 7, wherein the increased torque demands comprise moving the vehicle at the dynamic limiting speed and compensating for dynamic road conditions.

9. A method of dynamic road speed limiting for a vehicle, comprising:
(a) detecting a triggering event of the vehicle via a triggering detection component that is analyzed on an electronic control unit (ECU) of the vehicle to determine a dynamic road speed limiting operation state, comprising the steps of:
(i) setting a dynamic road speed limiter to an active state upon detecting the triggering event is occurring;
(ii) setting the dynamic road speed limiter to an inactive state upon determining that the triggering event is not occurring;
(b) while operating in the active state, managing a dynamic limiting speed, further comprising:
(i) determining a current speed via the ECU,
(ii) setting the dynamic limiting speed of the vehicle to not exceed the current speed,
(iii) monitoring the current speed to detect a decrease of the current speed, and
(iv) matching the dynamic limiting speed to the current speed that is decreased not to surpass a target threshold speed;
(c) enacting a torque management control aspect to maintain the dynamic limiting speed in the active state, further comprising:
(i) receiving a torque demand from an operator via a torque demand component communicably connected to the ECU;
(ii) comparing the torque demand to the dynamic limiting speed; and
(iii) restricting a torque output of an engine such that the vehicle does not accelerate above the dynamic limiting speed.

10. The method of claim 9, wherein the ECU in the active state controls the torque output of the engine such that the current speed cannot exceed the dynamic limiting speed.

11. The method of claim 9, wherein the triggering event comprises a fault condition.

12. The method of claim 11, wherein upon the fault condition being detected, the dynamic road speed limiter is selectively used with traditional road speed limiters.

13. The method of claim 9, wherein the triggering event comprises a manual activation.

14. The method of claim 9, wherein the triggering event detection component continuously monitors for the triggering event while in the active state.

15. The method of claim 9, wherein the torque output is variable to compensate for increased torque demands required to maintain the dynamic limiting speed.
